(19) United States
(12) Patent Application Publication
(10) Pub. No.: US 2026/0175921 A1
(43) Pub. Date: Jun. 25, 2026

(54) VEHICLE FRONT PORTION STRUCTURE

(71) Applicant: TOYOTA JIDOSHA KABUSHIKI KAISHA, Toyota-shi (JP)

(72) Inventors: Hiromu KOTAKI, Seto-shi (JP); Shizuma UJU, Nisshin-shi (JP); Koji AMEMIYA, Okazaki-shi (JP)

(21) Appl. No.: 19/370,764

(22) Filed: Oct. 28, 2025

(30) Foreign Application Priority Data
Dec. 20, 2024 (JP) 2024-225340

(51) Int. Cl. B62D 25/08

(52) U.S. Cl. CPC B62D 25/088

(57) ABSTRACT

A vehicle front portion structure, include: a wheel house at which a front wheel is disposed and the wheel house including a vertical wall portion that extends in a vehicle front-rear direction and in a vehicle up-down direction; an upper member integrally molded with the wheel house, provided further to a rear side, in the vehicle front-rear direction, than a suspension tower that is provided at the wheel house, and the upper member being continuous with the vertical wall portion; a peripheral wall portion formed at an outer edge of the upper member and erected from the vertical wall portion toward a vehicle width direction outer side; and a plurality of bosses provided at the peripheral wall portion and formed thicker than the peripheral wall portion.

### CROSS-REFERENCE TO RELATED APPLICATION

This application claims priority under 35 USC 119 from Japanese Patent Application No. 2024-225340, filed December 20, 2024, the disclosure of which is incorporated by reference herein in its entirety.

### BACKGROUND

### Technical Field

The present disclosure relates to a vehicle front portion structure.

### Related Art

Chinese Publication (CN) No. 117565978 discloses technology related to a vehicle front portion structure including a cast main body that is formed by die casting.

In this technology, a cast main body is integrally formed from a pair of suspension towers, which support upper end portions of suspensions of front wheels, to left and right wheel houses, which are provided at vehicle rear sides of the front wheels, respectively, and the left and right wheel houses are connected by a cross member that configures a skeleton at a front end lower portion of a cabin and that extends in a vehicle width direction.

### SUMMARY

Note that in the above-described technology, plural ribs are formed at a vehicle width direction outer side of the cast main body. Therefore, when the cast main body is released from a mold for molding the cast main body, there is a possibility that the cast main body (an integral molding member) will meet mold release resistance due to formation of plural ribs and deform.

In consideration of the above-described circumstances, the present disclosure is to obtain a vehicle front portion structure that is capable of suppressing deformation of an integrally molded member during molding of the integrally molded member.

A vehicle front portion structure according to a first aspect includes: a wheel house at which a front wheel is disposed and the wheel house includes a vertical wall portion that extends in a vehicle front-rear direction and in a vehicle up-down direction; an upper member that is integrally molded with the wheel house, that is provided further to a rear side in the vehicle front-rear direction than a suspension tower provided at the wheel house, and the upper member is continuous with the vertical wall portion; a peripheral wall portion that is formed at an outer edge of the upper member and that is erected from the vertical wall portion toward a vehicle width direction outer side; and plural bosses that are provided at the peripheral wall portion and that are formed thicker than the peripheral wall portion.

The vehicle front portion structure according to the first aspect includes a wheel house and an upper member. The wheel house includes a vertical wall portion that extends in the vehicle front-rear direction and in the vehicle up-down direction. The upper member is integrally molded with the wheel house, is provided further to a rear side in the vehicle front-rear direction than a suspension tower provided at the wheel house, the upper member is provided between the suspension tower and a pillar, and is formed continuously with the vertical wall portion.

Note that in the present aspect, at an outer edge of the upper member, a peripheral wall portion is erected from the vertical wall portion toward the vehicle width direction outer side, and plural bosses that are formed thicker than the peripheral wall portion are provided at the peripheral wall portion.

The upper member is integrally molded with the wheel house, such that when the wheel house and the upper member (an integral molding member) are released from a mold, the integral molding member is pressed by extrusion pins. Bosses are provided at the integral molding member, and extrusion pins abut the bosses, thereby enabling the integral molding member to be released from the mold.

In the present aspect, the bosses are provided at the peripheral wall portion of the upper member, such that the rigidity of the peripheral wall portion and the bosses can be improved. Therefore, when releasing the integral molding member from a mold, extrusion pins press the bosses, such that the mold releasability of the integral molding member is improved by an amount corresponding to higher rigidity of the integral molding member compared to a case in which extrusion pins press the vertical wall portion, and deformation of the integral molding member including the wheel house can be suppressed. This improves the dimensional accuracy of the integrally molded member including the wheel house, and improves the fastening accuracy of an outer panel provided at a vehicle width direction outer side of the wheel house.

Note that the bosses being "formed thicker than the peripheral wall portion" means that the bosses and the peripheral wall portion are integral with each other due to the bosses being provided at the peripheral wall portion, thereby the peripheral wall portion becomes thicker.

A vehicle front portion structure according to a second aspect is the vehicle front portion structure according to the first aspect, in which: the bosses are formed at an inner face side of the peripheral wall portion; and an outer face of the peripheral wall portion is formed in a substantially flat shape.

In the vehicle front portion structure according to the second aspect, the bosses are formed at the inner face side of the peripheral wall portion, and an outer face of the peripheral wall portion is formed in a substantially flat shape. The bosses are formed thicker than the peripheral wall portion of the upper member, such that the bosses are formed at the inner face side of the peripheral wall portion, thereby enabling the shape of the outer face of the peripheral wall portion to be not affected, and enabling interference with other components around the upper member to be suppressed.

A vehicle front portion structure according to a third aspect is the vehicle front portion structure according to the first aspect, in which: at the upper member, plural first ribs are erected from the vertical wall portion toward the vehicle width direction outer side; and a draft angle of each of the first ribs is greater than a draft angle of other ribs at a portion other than the upper member.

In the vehicle front portion structure according to the third aspect, at the upper member, plural first ribs are erected from the vertical wall portion toward the vehicle width direction outer side. The draft angle of each of the first ribs is greater than the draft angle of other ribs at a portion other than the upper member, thereby improving mold releasability of the first ribs formed at the upper member from a mold.

A vehicle front portion structure according to a fourth aspect is the vehicle front portion structure according to the third aspect, wherein part of the plural first ribs are connected to the bosses.

In the vehicle front portion structure according to the fourth aspect, part of the plural first ribs are connected to the bosses, thereby improving the rigidity of the first ribs and the bosses, respectively.

As explained above, the vehicle front portion structure according to the present disclosure is capable of suppressing deformation of an integrally molded member during molding of the integrally molded member, improving the dimensional accuracy of the integrally molded member, and improving the fastening accuracy with a member provided at an outer side of the integrally molded member.

### BRIEF DESCRIPTION OF THE DRAWINGS

FIG. 1 is a perspective view of a vehicle to which a vehicle front portion structure according to the present exemplary embodiment is applied, viewed obliquely from the left rear side and upper side of the vehicle;

FIG. 2A is a schematic cross-sectional view illustrating a draft angle of a first rib formed at an upper member that configures part of a vehicle front portion structure according to the present exemplary embodiment; and

FIG. 2B is a schematic cross-sectional view illustrating a draft angle of a rib at a portion other than the upper member, illustrating a comparative example of FIG. 2A.

### DETAILED DESCRIPTION

Explanation follows regarding a vehicle front portion structure according to an exemplary embodiment of the present disclosure, with reference to the drawings. Note that in each of the drawings as appropriate, the arrow FR indicates the front side in a vehicle front-rear direction, and the arrow UP indicates the upper side in a vehicle up-down direction. The arrow RH indicates the right side in a vehicle width direction, and in the present exemplary embodiment, indicates a vehicle width direction outer side. In the following explanation, unless specifically stated otherwise, simple reference to the front and rear, up and down, and left and right directions refers to front and rear in the vehicle front-rear direction, up and down in the vehicle up-down direction, and left and right in a vehicle left-right direction (vehicle width direction).

### Configuration of the Vehicle Front Portion Structure

First, explanation follows regarding a configuration of a vehicle front portion structure according to the present exemplary embodiment.

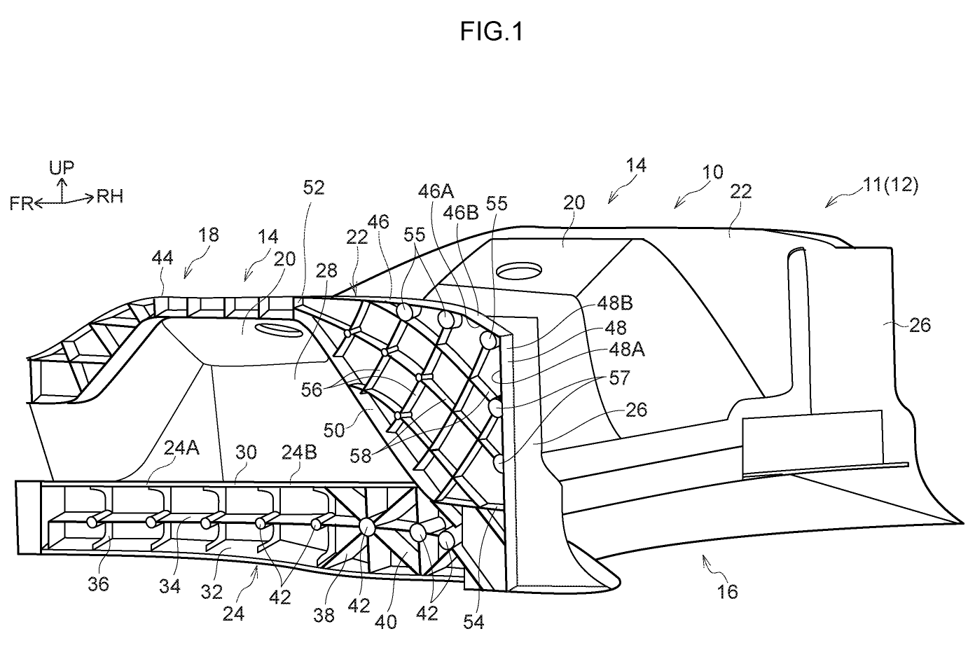

FIG. 1 illustrates a front portion (vehicle front portion) 11 of a vehicle 12 to which a vehicle front portion structure 10 according to the present exemplary embodiment is applied. Although not illustrated in the drawings, the vehicle 12 is, for example, an electric vehicle, a fuel cell vehicle, or the like which runs on power generated by a power unit.

In the vehicle 12 illustrated in FIG. 1, wheel houses 14, at which front wheels (not illustrated in the drawings) are disposed at the left and the right of the vehicle front portion 11, are respectively provided, and the right wheel house 14 and the left wheel house 14 are connected by a cross member 16. An apron upper member 18 extends along the front-rear direction at an upper end portion of each wheel house 14, and a suspension tower 20 is provided at a vehicle width direction inner side of each apron upper member 18.

An upper member 22 that extends in the up-down direction and in the front-rear direction is provided at a rear side of the suspension tower 20 and further toward a vehicle width direction outer side than the suspension tower 20. A front side member 24 that extends in the up-down direction and in the front-rear direction is provided below the suspension tower 20 and the upper member 22. Further, a front pillar (pillar) 26 that extends in the up-down direction and in the front-rear direction is provided at a rear side of the upper member 22 and the front side member 24.

A front end portion of a roof side rail, which is not illustrated in the drawings and which supports an upper end portion of a front door and extends in the front-rear direction, is coupled to each upper end portion of the front pillar 26. Further, a front end portion of a rocker, which is not illustrated in the drawings and which extends in the front-rear direction at a vehicle width direction outer side of a floor panel is connected to a lower side of the front pillar 26.

Note that in the present exemplary embodiment, the left and right wheel houses 14, including the suspension towers 20 and the front side members 24, the left and right upper members 22, and the cross member 16 are integrally molded (an integral molding member 25) by casting, for example, using an aluminum alloy, a magnesium alloy, or the like as a material.

In the integral molding member 25 in the present exemplary embodiment, in view of the structure of a mold, for example, in forming the faces at the vehicle width direction outer side of the wheel house 14 and the upper member 22, the mold is slid toward the vehicle width direction outer side. Therefore, the wheel house 14 and the upper member 22 are formed such that the vehicle width direction outer sides are open.

### Wheel House

First, explanation follows regarding the wheel house 14 in the present exemplary embodiment.

As described above, the left and right pair of wheel houses 14 each includes the suspension tower 20 and the front side member 24. As illustrated in FIG. 1, the wheel house 14 includes a vertical wall portion 28 that extends in the front-rear direction and in the up-down direction at an inner side of a fender panel of the vehicle, which is not illustrated in the drawings. Note that the vertical wall portion 28 is formed bulging out toward a vehicle width direction inner side along the shape of the suspension tower 20 at the upper side of the front side member 24, which is described below.

Further, as described above, the apron upper member 18 is provided at the upper end portion of the wheel house 14, and the front side member 24 extends in the front-rear direction at a lower portion of the wheel house 14.

The front side member 24 includes an upper wall portion 30 that configures an upper end portion of the front side member 24 extending along the front-rear direction, and a lower wall portion 32 that configures a lower end portion of the front side member 24. Plural lateral wall portions 34 extend along the front-rear direction between the upper wall portion 30 and the lower wall portion 32, and the upper wall portion 30, the lower wall portion 32, and the lateral wall portions 34 are each erected from the vertical wall portion 28 toward the vehicle width direction outer side.

Further, plural vertical ribs 36 are provided along the up-down direction between the upper wall portion 30 and the lower wall portion 32 at a front portion 24A side of the front side member 24, and the vertical ribs 36 are arrayed along the front-rear direction.

At a rear portion 24B side of the front side member 24, plural inclined ribs 38 that incline toward an upper side on progression toward a rear side and plural inclined ribs 40 that incline toward a lower side on progression toward the rear side are provided between the upper wall portion 30 and the lower wall portion 32, and the inclined ribs 38 and the inclined ribs 40 are connected to configure a truss structure with the lateral wall portions 34 disposed therebetween. In this manner, the inclined ribs 38 and the inclined ribs 40 are connected to each other with the lateral wall portions 34 therebetween, such that a bending moment is unlikely to occur, and deformation is suppressed.

Further, a boss 42 that has a substantially cylindrical shape or a substantially columnar shape is provided at an intersection point between the inclined ribs 38 and 40 and the lateral wall portion 34, and at the lateral wall portions 34. The bosses 42 are bases against which extrusion pins, which are not illustrated in the drawings and are used when releasing the integral molding member 25 from a mold, abut when molding the integral molding member 25 including the wheel house 14.

Note that the position, size, and the like of the boss 42 can be appropriately changed depending on the mass balance of the integral molding member 25. Further, the boss 42 may be used not only as a base against which an extrusion pin abuts, but also as a base for fastening with other components.

### Upper Member

Next, explanation follows regarding the upper member 22 in the present exemplary embodiment.

A left and right pair of upper members 22 are respectively provided between the suspension tower 20 and the front pillar 26 of the wheel house 14 along the front-rear direction, and at the upper side of the front side member 24.

The upper member 22 is connected to the wheel house 14 at the vehicle width direction inner side, and includes the vertical wall portion 28 that extends in the front-rear direction and in the up-down direction. The upper member 22 has a substantially triangular shape in side view from the vehicle outer side, and an upper wall portion (peripheral wall portion) 46 that is connected to an upper end portion 44 configuring an upper end of the apron upper member 18 is erected from an upper end of the vertical wall portion 28 toward the vehicle width direction outer side, and extends along the front-rear direction.

At a rear end of the upper member 22, a rear wall portion (peripheral wall portion) 48 that forms a boundary between a rear end of the upper wall portion 46 and the front pillar 26 is erected from a rear end of the vertical wall portion 28 toward the vehicle width direction outer side, and is formed along the up-down direction. At a front end of the upper member 22, an inclined rib 50 that forms a boundary with the wheel house 14 is erected from the vertical wall portion 28 toward the width direction outer side, and is formed inclined toward the lower side on progression toward the rear side.

A rear wall portion 52 that configures a rear end of the apron upper member 18 and extends in the up-down direction and in the width direction is provided between an upper end of the inclined rib 50 and a front end of the upper wall portion 46. Further, at a lower end of the upper member 22, a lower wall portion 54 that forms a boundary with the front side member 24 is erected from the vertical wall portion 28 toward the vehicle width direction outer side, and is formed along the front-rear direction.

Namely, in the present exemplary embodiment, a boundary between the upper member 22 (the outer edge of the upper member 22) and other portions of the integral molding member 25 is configured by the upper wall portion 46, the rear wall portion 52 of the apron upper member 18, the inclined rib 50, the rear wall portion 48, and the lower wall portion 54.

Note that plural columnar shaped bosses 55 and 57 are provided at the upper wall portion 46 and the rear wall portion 48, respectively. The bosses 55 and 57 are thicker than the upper wall portion 46 and the rear wall portion 48, and are formed at approximately the same height (approximately the same plane) as the upper wall portion 46 and the rear wall portion 48.

Plural first arc ribs 56 (first ribs) extend from the inclined rib 50 toward the upper side on progression toward the rear side, and gently bulge out toward the rear side and the lower side in a convex shape. The first arc ribs 56 are erected from the vertical wall portion 28 toward the vehicle width direction outer side, and are disposed with a gap therebetween. Note that upper ends of the first arc ribs 56 are connected to the upper wall portion 46, the bosses 55 provided at the upper wall portion 46, and the boss 57 provided at the rear wall portion 48, respectively.

Further, in the present exemplary embodiment, plural second arc ribs 58 (first ribs) intersect with the plural first arc ribs 56. The second arc ribs 58 are formed so as to head toward the lower side on progression toward the rear side, and to gently bulge out toward the rear side and the upper side in a convex shape.

Further, the second arc ribs 58 are erected from the vertical wall portion 28 toward the vehicle width direction outer side, and are disposed with a gap therebetween. Note that front ends of the second arc ribs 58 are connected to the inclined rib 50, the rear wall portion 52, and the upper wall portion 46, respectively, and rear ends of the second arc ribs 58 are connected to the bosses 57 provided at the rear wall portion and the rear wall portion 48, respectively.

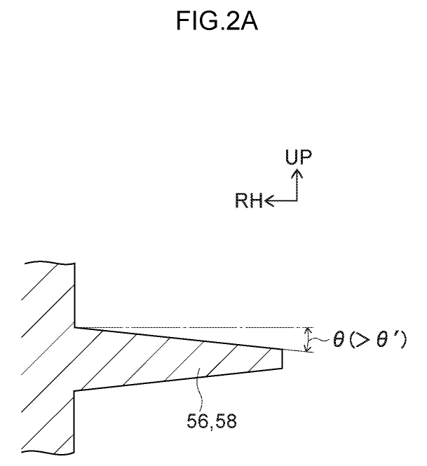

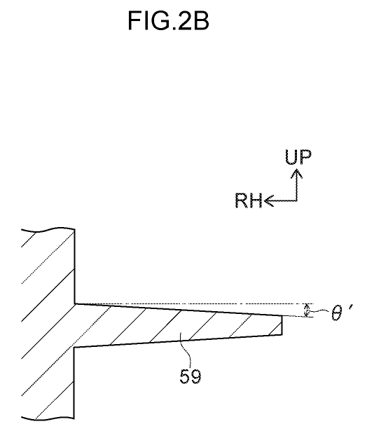

Moreover, as illustrated in FIG. 2A and FIG. 2B, in the present exemplary embodiment, the draft angles θ of the first arc ribs 56 and the second arc ribs 58 are greater than the draft angles θ' of ribs formed at portions other than the upper member 22, such as the wheel house 14 (see FIG. 1) (θ > θ'), for example.

### Operation and Effects of the Vehicle Front Portion Structure

Next, explanation follows regarding the operation and effects of the vehicle front portion structure according to the present exemplary embodiment.

As illustrated in FIG. 1, the present exemplary embodiment includes the wheel house 14 and the upper member 22. The wheel house 14 includes the vertical wall portion 28 extending in the front-rear direction and in the up-down direction. The upper member 22 is integrally molded with the wheel house 14, is provided further toward the rear side in the front-rear direction than the suspension tower 20 provided at the wheel house 14, and is formed continuously with the vertical wall portion 28.

Note that plural columnar shaped bosses 55 and 57 are provided at the upper wall portion 46 and the rear wall portion 48 corresponding to portions of the outer edge of the upper member 22, respectively. The upper member 22 is integrally molded with the wheel house 14. Therefore, when releasing the integral molding member 25 from a mold that molds the integral molding member 25, including the wheel house 14 and the upper member 22, the integral molding member 25 is pressed by extrusion pins.

In the present exemplary embodiment, the bosses 55 and 57 are provided at the upper wall portion 46 and the rear wall portion 48 of the upper member 22, respectively. By providing the bosses 55 and 57 at the upper wall portion 46 and the rear wall portion 48, respectively, the rigidity of the upper wall portion 46, the rear wall portion 48, and the bosses 55 and 57, respectively, can be improved.

Therefore, when releasing the integral molding member 25 from a mold, extrusion pins, which are not illustrated in the drawings, press the bosses 55 and 57, thereby improving the mold releasability of the integral molding member 25 by an amount corresponding to higher rigidity of the integral molding member compared to a case in which extrusion pins press the vertical wall portion 28, and enabling deformation of the integral molding member 25 to be suppressed.

Further, since the bosses 55 and 57 are provided at the circumference edge of the upper member 22 (the upper wall portion 46 and the rear wall portion 48), namely, the outer edge of the integral molding member 25, when the integral molding member 25 is released from a mold, at least the outer edge of the integral molding member 25 is pressed by extrusion pins, enabling the integral molding member 25 to be effectively released from the mold.

In this manner, in the present exemplary embodiment, improving the mold releasability of the integral molding member 25 from a mold increases the dimensional accuracy of the integral molding member 25, and improves the fastening accuracy of an outer panel (not illustrated in the drawings) provided at a vehicle width direction outer side of the wheel house 14. Improving the dimensional accuracy of the integral molding member 25 in this manner enables the wheel house 14 and the front pillar 26 to be integrally molded as part of the integral molding member 25.

In the present exemplary embodiment, the bosses 55 and 57 are thicker than the upper wall portion 46 and the rear wall portion 48 of the upper member 22. Therefore, part of the outer peripheral surfaces of the bosses 55 and 57 project out from an inner face 46A or an outer face 46B of the upper wall portion 46, and from an inner face 48A or an outer face 48B of the rear wall portion 48. Accordingly, the bosses 55 and 57 are formed projecting out from the inner face 46A of the upper wall portion 46 and the inner face 48A of the rear wall portion 48. Note that the outer face 46B of the upper wall portion 46 and the outer face 48B of the rear wall portion 48 may be formed in a substantially flat shape.

Forming the bosses 55 and 57 so as to project out at the inner face 46A of the upper wall portion 46 and the inner face 48A of the rear wall portion 48 enables the shape of the outer face 46B of the upper wall portion 46 and the shape of the outer face 48B of the rear wall portion 48 to be prevented from being affected, thereby enabling interference with other components around the upper member 22 to be suppressed.

Note that in the present exemplary embodiment, although the bosses 55 and 57 are provided separately from the fastening portions of the outer panel, the bosses 55 and 57 may also be used as the fastening portions.

As illustrated in FIG. 2A and FIG. 2B, in the present exemplary embodiment, at the upper member 22, plural first arc ribs 56 and plural second arc ribs 58 are erected from the vertical wall portion 28 toward the vehicle width direction outer side. The draft angles θ of the first arc ribs 56 and the second arc ribs 58 are greater than the draft angles θ′ of other ribs 59 that are formed at portions other than the upper member 22, thereby improving the mold releasability of the first arc ribs 56 and the second arc ribs 58, formed at the upper member 22, from a mold.

The first arc rib 56 may be connected to the boss 55, and the second arc rib 58 may be connected to the boss 57. As a result, the rigidity is improved in each of the first arc rib 56 and the boss 55, the second arc rib 58 and the boss 57. Further, in the present exemplary embodiment, thickening in order to ensure rigidity is unnecessary in each of the first arc rib 56 and the boss 55, and the second arc rib 58 and the boss 57, respectively, compared to a case in which each of these are provided separately, thereby enabling the volume to be reduced correspondingly, and enabling weight reduction to be achieved.

In the present exemplary embodiment, plural first arc ribs 56 and plural second arc ribs 58 are erected at the upper member 22 that is provided between the suspension tower 20, which is provided at the wheel house 14, and the front pillar 26. Therefore, in a collision in the vehicle front-rear direction, the plural first arc ribs 56 and the plural second arc ribs 58 are crushed, thereby enabling collision energy to be absorbed.

Note that in the present exemplary embodiment, as illustrated in FIG. 2A and FIG. 2B, the draft angles θ of the first arc ribs 56 and the second arc ribs 58 are greater than the draft angles θ′ of ribs 59 formed at portions other than the upper member 22 (θ > θ').

This enables the mold releasability of the first arc ribs 56 and the second arc ribs 58 to be improved in the present exemplary embodiment, and enables adverse effects (deformation or the like) that may be caused by providing the plural first arc ribs 56 and the plural second arc ribs 58 to be reduced when the integral molding member 25 is released from a mold.

### Supplementary Explanation of the above-described Exemplary Embodiment

In the above-described exemplary embodiment, explanation has been made such that the boundary between the upper member 22 and other portions is configured by the rear wall portion 52 of the apron upper member 18, the inclined rib 50, and the lower wall portion 54. However, in the present exemplary embodiment, a boundary is set only for convenience of explanation of the upper member 22, and the upper member 22 is a portion of the integral molding member 25 including the wheel house 14, such that where to set the range of the upper member 22 can be appropriately changed. For example, a rear end portion of the front side member 24 may be part of the upper member 22.

In the present exemplary embodiment, the first arc rib 56 and the second arc rib 58 are formed in an arc shape; however, they are not necessarily required to be formed in an arc shape, and may be formed in a linear shape. Further, the wall thicknesses of the first arc rib 56 and the second arc rib 58 are not necessarily required to be constant along the extension direction, and for example, an intersection portion with another portion may be thicker.

Note that the heights of the first circular arc rib 56 and the second circular arc rib 58 are not necessarily required to be constant along the extension direction, and may be partially formed low in order to accelerate cooling, taking into consideration a balance between cooling times with other portions of the upper member 22 during molding of the integral molding member 25.

Note that in the present exemplary embodiment, the left and right wheel houses 14, the left and right upper members 22, and the cross member 16 are integrally molded as the integral molding member 25 by casting, using an aluminum alloy or the like as a material; however, the present disclosure is not limited thereto. The integral molding member 25 may be integrally molded of CFRP, GFRP, or the like, for example.

In the present exemplary embodiment, the left and right wheel houses 14, the left and right upper members 22, and the cross member 16 are integrally molded; however, it is sufficient that the wheel house 14 and the upper member 22 are integrally molded, and the left and right wheel houses 14, or the left and right upper members 22 are not necessarily required to be integrally molded.

In the present exemplary embodiment, although the front side member 24 is integrally molded with the wheel house 14, the front side member 24 and the wheel house 14 do not necessarily have to be integrally molded. The front side member 24 may be fixed to a lower side of the wheel house 14 as a separate member. In such a case, materials can be changed between the wheel house 14 and the front side member 24, and manufacturing methods can be changed with respect to the integral molding member 25, such as extrusion molding.

In the present exemplary embodiment, although explanation has not been made that the front pillar 26 is integrally molded with the integral molding member 25, it is needless to say that the front pillar 26 may be integrally molded with the integral molding member 25. However, in a case in which the front pillar 26 is formed as a separate member from the integral molding member 25, the materials of the front pillar 26 and the integral molding member 25 can be changed. In such a case, the manufacturing method of the front pillar 26 can be changed from that of the integral molding member 25, such as press molding.

Although one exemplary embodiment of the present disclosure has been explained above, the present disclosure is not limited to such exemplary embodiment, and one exemplary embodiment and various modified examples may be used in combination as appropriate, and it is needless to say that the present disclosure may be practiced in various modes within a range not departing from the scope of the present disclosure.

What is claimed is:

1. A vehicle front portion structure, comprising:
a wheel house at which a front wheel is disposed and the wheel house including a vertical wall portion that extends in a vehicle front-rear direction and in a vehicle up-down direction;
an upper member integrally molded with the wheel house, provided further to a rear side, in the vehicle front-rear direction, than a suspension tower that is provided at the wheel house, and the upper member being continuous with the vertical wall portion;
a peripheral wall portion formed at an outer edge of the upper member and erected from the vertical wall portion toward a vehicle width direction outer side; and
a plurality of bosses provided at the peripheral wall portion and formed thicker than the peripheral wall portion.

2. The vehicle front portion structure according to claim 1, wherein:
the bosses are formed at an inner face side of the peripheral wall portion; and
an outer face of the peripheral wall portion is formed in a substantially flat shape.

3. The vehicle front portion structure according to claim 1, wherein:
at the upper member, a plurality of first ribs are erected from the vertical wall portion toward the vehicle width direction outer side; and
a draft angle of the first ribs is greater than a draft angle of ribs that are formed at a portion other than the upper member.

4. The vehicle front portion structure according to claim 3, wherein part of the plurality of first ribs are connected to the bosses.
